(19) United States
(12) Patent Application Publication
(10) Pub. No.: US 2016/0186076 A1
(43) Pub. Date: Jun. 30, 2016

(54) SYSTEMS FOR AMMONIATED QUENCHING OF A HYDROPROCESSING REACTION

(71) Applicant: PHILLIPS 66 COMPANY, Houston, TX (US)

(72) Inventor: Steven A. TREESE, Katy, TX (US)

(73) Assignee: PHILLIPS 66 COMPANY, Houston, TX (US)

(21) Appl. No.: 14/831,960

(22) Filed: Aug. 21, 2015

Related U.S. Application Data
(60) Provisional application No. 62/098,834, filed on Dec. 31, 2014.

(51) Int. Cl. C10G 47/36; B01J 19/24

(52) U.S. Cl. CPC C10G 47/36; B01J 19/24; B01J 2219/00058; B01J 2219/24

(57) ABSTRACT

The disclosure provided herein describes systems for rapidly quenching an over-temperature hydroprocessing reaction utilizing a pressurized quenching agent that is rapidly released into the hydroprocessing reactor. Optimally, the quenching agent blocks acidic catalytic sites of the hydroprocessing catalyst to competitively inhibit exothermic reaction rate. Exemplary quench agents include ammonia or a chemical that is converted to ammonia under hydroprocessing conditions.

### CROSS-REFERENCE TO RELATED APPLICATIONS

This application is a Non-Provisional application which claims the benefit under 35 USC §119(e) of U.S. Provisional Application Ser. No. 62/098,834 filed Dec. 31, 2014, titled “Systems for Ammoniated Quenching of a Hydroprocessing Reaction,” which is hereby incorporated by reference in its entirety.

### STATEMENT REGARDING FEDERALLY SPONSORED RESEARCH OR DEVELOPMENT

None.

### BACKGROUND

Hydroprocessing reactions are highly exothermic, especially hydrocracking reactions. In a petroleum refinery, temperatures generated during operation of hydroprocessing reactors are managed by (1) inlet temperature to the reactor, (2) continuous flow of fluids through the reactor to remove the heat generated, and in many cases, (3) introduction of quench gas or oil into specially designed “quench zones” inside the reactor. Hydrocrackers also generally include emergency quench that can be introduced at the reactor inlet, if necessary. The quenches can be warm, cold or a combination, but typically comprise fluids that are relatively cool, recycled and hydrogen-rich.

Under certain conditions, it is possible to lose control of the temperatures in the reactor, resulting in very high temperatures. If the temperatures are rising radically, this loss of control is usually referred to as a “temperature excursion.” If the temperatures rise rapidly or are very high already, exothermic hydrocracking/hydrodemethylation reactions can begin to dominate, even in a hydrotreating reactor. The rapidly rising temperatures are referred to as a “hydrocracking runaway.” Such an event cannot be stopped by normal quenching. The acidic hydroprocessing catalyst enhances the runaway reactions. The crossover from a controllable excursion to an uncontrolled runaway generally occurs between 800 and 850° F., although it can be lower in a hydrocracking reactor.

There are only limited options to stop runaway hydroprocessing reactions and regain control. The runaway reaction is supported by the presence of concentrated reactants (e.g., hydrogen and oil), temperature, and the catalyst in the reactor. Conventional emergency protocol involves rapid elimination of the hydrogen by rapid pressure reduction (or de-pressuring) of the unit. De-pressuring dumps the hydrogen at high rate to the refinery flare, in addition to stopping the input of fired heat and, usually, feedstock to the reactor. This is sufficient to stop the runaway event, but can result in massive flaring, which may violate emissions regulations. Reluctance to de-pressurize in a timely manner during a runaway hydroprocessing reaction has resulted in equipment failures and fatalities.

Accordingly, a need exists for better systems and methods for controlling potentially dangerous temperature excursions and runaway hydroprocessing reactions in a petroleum refinery setting.

### BRIEF SUMMARY OF THE DISCLOSURE

Certain embodiments of the system for quenching a catalytic hydroprocessing reaction comprise: a) a hydroprocessing reactor comprising a reaction zone and containing a hydroprocessing catalyst comprising at least one acidic catalytic active site, where the hydroprocessing reactor operates to maintain a temperature and pressure that facilitates hydroprocessing reactions, where the hydroprocessing reactor operates to facilitate contact between the acidic catalytic sites of the hydroprocessing catalyst and a feedstock derived from petroleum and/or biomass to produce a reactor effluent; b) a vessel that is connected to the hydroprocessing reactor via a conduit comprising a valve, where the vessel is capable of containing a quenching agent that binds the acidic catalytic active site(s), where the valve operates to release the quenching agent into the conduit and the conduit operates to convey the quenching agent to the reaction zone of the hydroprocessing reactor; c) at least one temperature sensor connected to the hydroprocessing reactor that is capable of sending an electrical signal indicating the temperature condition within the reaction zone; d) a control panel that operates to receive and interpret the electrical signal from the temperature sensor(s), and further operates to signal the first valve to operate to release the quenching agent when the electrical signal from the temperature sensor indicates a temperature condition that exceeds a first predetermined threshold temperature.

In certain embodiments, the system additionally includes a second conduit that operates to convey the reactor effluent from the hydroprocessing reactor, wherein the second conduit comprises a second valve that operates to receive wash water to mix with the reactor effluent, where the second valve operates to close in response to a signal from the control panel, where the control panel operates to send the signal to the second valve in response to an electrical signal from the temperature sensor indicating a temperature condition that exceeds a second predetermined threshold temperature. Optionally, the second predetermined threshold temperature is equal to or greater than the first predetermined threshold temperature.

Certain embodiments of the system further comprise a pretreating reactor connected upstream from the hydroprocessing reactor and containing one or more catalysts suitable for de-aromatization, de-metallization, hydrodesulfurization, and/or hydrodenitrogenation reactions. The pretreating reactor can be maintained at a temperature and pressure that facilitates at least one of these catalytic reactions.

In certain embodiments of the system, the quenching agent comprises ammonia or a compound that is converted to ammonia at a temperature and pressure that facilitate hydroprocessing reactions. Optionally, the vessel can operate to contain the quenching agent at a pressure in a range from 100 to 4000 psig.

In certain embodiments of the system, the first and second valves each comprise motorized or hydraulic components that are independently operable in response to an electric signal input from the control panel in the event that the temperature inside the hydroprocessing reactor above a predetermined threshold temperature.

In certain embodiments of the system, the first predetermined threshold temperature is at least 473° C. (820° F.), at least 476° C. (825° F.), at least 479° C. (830° F.), at least 482° C. (835° F.), at least 484° C. (840° F.), at least 487° C. (845° F.), or even at least 490° C. (850° F.).

In certain embodiments of the system, the hydroprocessing reactor is configured to facilitate exothermic reactions selected from hydrocracking, hydrodemethylation or both. Optionally, the hydroprocessing catalyst is a hydrocracking catalyst.

### BRIEF DESCRIPTION OF THE DRAWINGS

A more complete understanding of the present invention and benefits thereof may be acquired by referring to the follow description taken in conjunction with the accompanying drawings in which:

FIG. 1 depicts a schematic of an embodiment comprising a rapid ammoniated quenching system on a hydroprocessing reactor.

FIG. 2 depicts a schematic of an embodiment comprising a ammoniated quenching system on a single-stage hydrocracker.

The invention is susceptible to various modifications and alternative forms, specific embodiments thereof are shown by way of example in the drawings. The drawings may not be to scale. It should be understood that the drawings and their accompanying detailed descriptions are not intended to limit the scope of the invention to the particular forms disclosed. Rather, the intention is to cover all modifications, equivalents and alternatives encompassed by the spirit and scope of the claims.

### DETAILED DESCRIPTION

The disclosure provided herein describes processes and systems for rapidly quenching an over-temperature hydroprocessing reaction in a commercial refinery setting. In its most basic form, the inventive process and system rapidly adds a quenching agent to at least one of: the recycle gas, treat gas, or the quench gas. The inventive processes and systems are optimally employed during an over-temperature excursion as a first course of action that is a less drastic alternative than de-pressurization of the hydroprocessing reactor by rapid venting to the atmosphere or to the flare system of a refinery.

Certain embodiments of the rapid quenching system and processes disclosed herein additionally include a mechanism for preventing the removal of the quenching agent by the effluent wash water from the system, thereby allowing the added quenching agent to recycle in the treat gas and enhance the quenching effect. This is primarily intended for use in situations where dangerous loss of temperature control is imminent and the systems and processes are intended to be utilized as a temporary measure to reduce system temperatures back to a safe level while other measures are being taken, such as (but not limited to) decreasing charge heater temperature, reducing feedstock feed rate, etc.

In extreme circumstances, rapid quenching of the hydroprocessing reaction can optionally be combined with depressurization of the reactor as an added safety measure in events where equipment damage is imminent or a serious safety hazard is present.

In certain embodiments, rapid quenching of the hydroprocessing reaction can additionally be used as a safety measure after an emergency over-temperature event. In such instances, the hydroprocessing reactor remains hot and the system must be re-pressurized to a certain extent to enable circulation of recycle gas and also to enable cooling via adding a quenching agent to the makeup or circulating gas.

Hydroprocessing in a refinery setting is conventional in nature and will not be outlined herein beyond the detail required to understand the inventive systems and processes. Certain embodiments of the inventive process and system comprise storing sufficient quenching agent (e.g., ammonia or other ammonia-generating compound) in a pressurized vessel that is rapidly-discharged when needed to quench an over-temperature condition in the hydroprocessing reactor. Various injection points for the quench are feasible while still enabling the system to work effectively. Design details can vary significantly, depending on the specific hydroprocessing units utilized in a given embodiment, but universally result in rapid addition of quenching agent to the system. In one embodiment, pressurized ammonia (or other compound that generates ammonia under hydroprocessing conditions) is injected into a conduit that carries the treat gas and the resulting mixture is injected directly into the hydroprocessing reactor.

Hydrocracking and hydrodemethylation reactions tend to occur at acidic sites on hydroprocessing catalysts. While not wishing to be bound by theory, ammonia is believed to interact directly with these acidic sites on the catalyst to rapidly, yet reversibly, decrease hydroprocessing reaction rate. This interaction may involve competitive inhibition, or alternatively, reversible deactivation of the acidic active sites to slow the reaction rate.

The catalyst utilized for the invention may be any catalyst capable of facilitating hydroprocessing reactions. This includes, but is not limited to, any catalyst currently known to be useful for hydrotreating, hydrocracking, or catalyst mixtures comprising more than one of these catalysts. Such catalysts are conventional in nature and thus will not be recited here. The quenching agent may react with all catalysts, or only a portion of the catalysts present in the catalyst mixture.

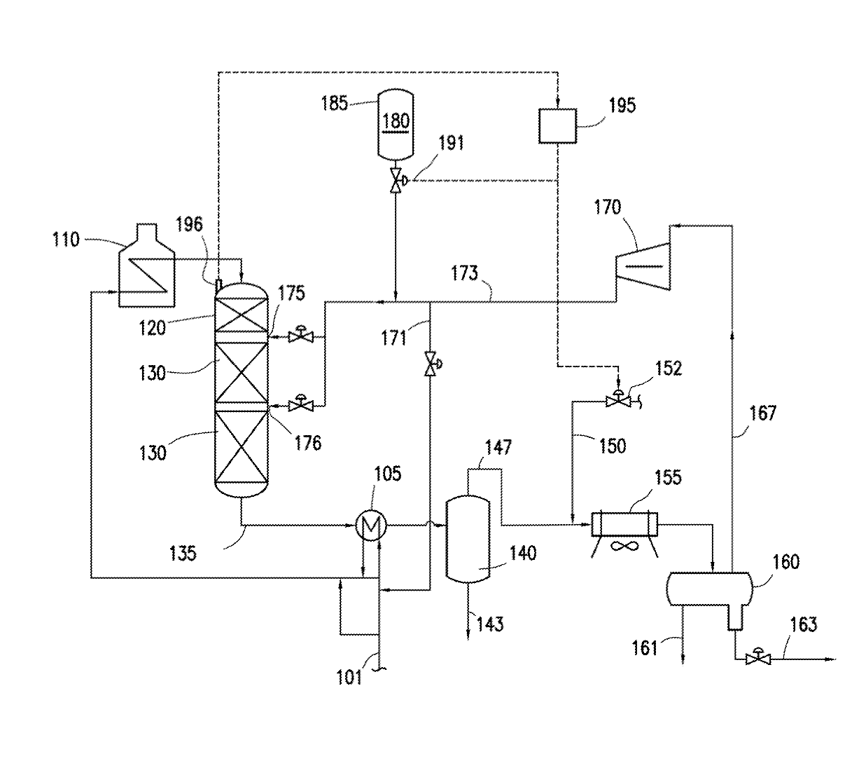

FIG. 1 depicts a more detailed schematic representation of one embodiment of the current disclosure comprising rapid quenching in a hydroprocessing reactor system. At least a portion of a feedstock 101 that may be derived from petroleum, biomass, or mixtures of these is first heated by feed/effluent heat exchanger 105. The feedstock is then conveyed to charge heater 110, which further heats the feedstock, then conveys the heated feedstock to a hydrotreating reactor 120 that is maintained at a temperature that generally ranges from 290° C. to 427° C. (550° F. to 800° F.). The hydrotreating reactor 120 contains a hydrotreating catalyst 130 that contacts the mixture comprising feedstock and hydrogen in the reactor 120 and facilitates conversion to a reactor effluent 135 comprising a mixture of hydrocarbons, hydrogen sulfide, unreacted hydrogen and other light gases and reaction products. The details of these reactions are conventional in nature and will not be discussed further.

Further referring to FIG. 1, the reactor effluent 135 is at least partially cooled as it is conveyed through feed/effluent heat exchanger 105, then is conveyed to hot high pressure separator 140 to separate treated liquid components 143 from gaseous components 147 that generally include unreacted hydrogen, light hydrocarbons (C₁-C₄) and H₂S. Note that the hot high pressure separator 140 is not required for all types of hydroprocessing systems and processes. The gaseous components 147 are diluted by addition of wash water 150 with the quantity of wash water added controlled by water inlet valve 152. The gaseous components mixed with wash water are then cooled by air cooler 155 before entering cold high pressure separator 160. A sour water outlet 163 removes separated liquid sour water from the cold high pressure separator 160, while a second outlet removes separated recycle gas 167 predominantly comprising hydrogen and light hydrocarbons (C₁-C₄) from the cold high pressure separator 160. A third outlet 161 from the cold high pressure separator 160 removes liquid hydrocarbons that can be further converted to a transportation fuel or a component thereof.

The separated recycle gas 167 is compressed in a recycle compressor 170 to form a treat gas 173 that may be returned to the hydrotreating reactor 120 in any of several ways. Referring to FIG. 1, a variable first portion of the treat gas is directed via conduit 171 to be added to the feedstock 101 at a point located upstream from the charge heater 110. Optionally, the first portion of treat gas 173 is added to the feedstock 101 at a point that is located upstream from feed/effluent heat exchanger 105. A variable second portion of the treat gas 173 is added directly to the hydrotreating reactor 120 through one or more inlets (175, 176) to mix with the feedstock 101 and provide a source of hydrogen for hydrotreating and temperature control by quenching.

Again referring to the embodiment depicted in FIG. 1, in the event of an over-temperature event within the reaction zone of hydrotreating reactor 120, or an elevated runaway temperature condition that necessitates emergency intervention to slow the rate of exothermic reactions taking place in the hydrotreating reactor 120, a pressurized quenching agent 180 is released from quench vessel 185 by the operation of valve 191. Optimally, valve 191 is capable of opening rapidly to release the pressurized quenching agent 180 to mix with the treat gas 173 at a point that is immediately upstream from where the treat gas 173 enters the hydrotreating reactor 120 via inlets 175 and 176. The mixture of quenching agent 180 and treat gas 173 may then be conveyed into the hydrotreating reactor 120 via the inlets 175, 176, and/or conveyed via conduit 171 to mix with the feedstock at a point located upstream from the charge heater 110. In certain embodiments, the threshold hydrotreating reactor temperature at which valve 191 is opened may be , for example, 473° C. (820° F.), 476° C. (825° F.), 479° C. (830° F.), 482° C. (835° F.), 484° C. (840° F.), 487° C. (845° F.), or even 490° C. (850° F.).

In certain embodiments, the system also includes one or more valves that when opened, stops the flow of water that washes the reactor effluent, thereby increasing recycling of the quenching agent to the reaction zone of the hydroprocessing reactor. Again referring to the embodiment depicted in FIG. 1, valve 197 can be closed to prevent the addition of wash water 150 to the system.

Optionally, the valves that control entry of quenching agent or wash water may be automated to by operated (i.e. opened and closed) remotely by signals from control panel 195. FIG. 1 depicts control panel 195 operably connected to remotely control the operation of valve 191 and valve 152 via an electrical signal. In certain embodiments, each valve may comprise motorized or hydraulic components adapted to operate the valve in response to an electric signal input, and operation of each valve may be controlled independently from the other valves by the control panel. Further, the control panel 195 may be electrically interfaced with, and operable to receive electrical signal input from one or more temperature sensors located on or within the hydrotreating reactor. In the embodiment depicted in FIG. 1, control panel 195 comprises a programmable computing device and is further operable to respond to input from temperature sensor 196. When the control panel 195 detects a temperature via electrical signal input from the temperature sensor 196 that exceeds a predetermined first threshold temperature, control panel 195 sends a signal to open valves 191 and/or 152, thereby rapidly quenching the over-temperature condition via the mechanisms described previously. In certain embodiments, this first pre-determined threshold temperature may be, for example, 473° C. (820° F.), 476° C. (825° F.), 479° C. (830° F.), 482° C. (835° F.), 484° C. (840° F.), 487° C. (845° F.), or even 490° C. (850° F.). In certain embodiments, the control panel 195 detects a temperature via signal input from the temperature sensor 196 that exceeds a second predetermined threshold temperature that is greater than the first predetermined threshold temperature. In response, control panel 195 sends a signal to open valves 191, 152, or both to rapidly quench the over-temperature condition via the mechanisms described previously.

FIG. 2 depicts a more detailed schematic representation of an alternative embodiment of the inventive system and process integrated with a system for single-stage hydrocracking of a hydrocarbon feedstock. Conventional hydrocracking reactors are typically maintained at a temperature in the range from 448° C. to 476° C. (775° F. to 825° F.). The upper end of this range is higher than the temperatures typically utilized for hydrotreating reactors. Therefore, the threshold temperature at which the emergency quenching system described herein would be utilized would typically be higher when incorporated into a hydrocracking reactor system.

At least a portion of a feedstock 201 that may be derived from petroleum, biomass, or mixtures of these is first heated by feed/effluent heat exchanger 205. The feedstock 201 is then conveyed to a charge heater 210, which further heats the feedstock 201 and conveys it to a pretreating reactor 215. The pre-treating reactor 215 contains one or more pretreating catalysts 216 that are useful for removing metals, complex aromatics (e.g, asphaltenes), as well as sulfur and nitrogen from the feedstock 201. In general, pretreating of the feedstock 201 in such a manner prior to contacting the feedstock with a hydrocracking catalyst prevents premature deactivation of the hydrocracking catalyst. Referring again to FIG. 2, pretreated feedstock 218 leaves the pretreating reactor 215 and is conveyed to a hydrocracking reactor 220, which facilitates mixing of the pretreated feedstock 218 with hydrogen and a hydrocracking catalyst 230 to facilitate conversion of the pretreated feedstock 218 to a hydrocracking reactor effluent 235 comprising a mixture of hydrocarbons and unreacted hydrogen. The details of these hydrocracking reactions are conventional in nature and will not be discussed further.

Further referring to FIG. 2, the hydrocracking reactor effluent 235 is at least partially cooled as it is conveyed through feed/effluent heat exchanger 205, then is conveyed to hot high pressure separator 240 to separate treated liquid components 243 from gaseous components 247 that generally include unreacted hydrogen, light hydrocarbons (C ₁-C₄) and H₂S. Note that the hot high pressure separator 240 is not required for all embodiments. The gaseous components 247 are cooled by treat gas preheat exchanger diluted by addition of wash water 250, with the quantity of wash water added controlled by water inlet valve 252. The gaseous components 247 mixed with wash water 250 are then cooled by air cooler 255 before entering cold high pressure separator 260. A sour water outlet 263 removes separated liquid sour water from the cold high pressure separator 260, while a second outlet removes separated recycle gas 267 predominantly comprising hydrogen and light hydrocarbons (C₁-C₄) from the cold high pressure separator 260. A third outlet 261 from the cold high pressure separator 260 removes the liquid hydrocarbons.

The separated recycle gas 267 is compressed in a recycle compressor 270 to form a treat gas 273 that may be returned to the hydrocracking reactor 220 in any of several ways. Referring to FIG. 2, a variable first portion of the treat gas 273 is directed via conduit 271 to be added to the feedstock 201 at a point 272 located upstream from the charge heater 210. In the embodiment depicted in FIG. 2, the variable first portion within conduit 271 is added to the feedstock 201 at a point that is located upstream from feed/effluent heat exchanger 205. A variable second portion of the treat gas 273 is added directly to the hydrocracking reactor 220 through one or more inlets 274, 275 and 276 and/or inlet 277 located just upstream from the hydrocracking reactor 220 to mix with the pretreated feedstock 218 and provide a source of hydrogen for hydrocracking and normal quenching for temperature control. A variable third portion of treat gas 273 may be added to the pre-treat reactor 215 via one or more inlets (278, 279) to provide a source of hydrogen for the de-metallization, de-aromatization, and hydrotreating reactions taking place there and for normal quenching for temperature control.

Again referring to the embodiment depicted in FIG. 2, in the event of over-temperature excursion within the hydrocracking reactor 220, or an elevated runaway temperature condition that necessitates emergency intervention to slow the rate of exothermic reactions taking place in the hydrocracking reactor 220, a pressurized quenching agent 280 is released from quench vessel 285 by the operation of valve 291. Optimally, valve 291 is capable of opening rapidly to release the pressurized quenching agent 280 to mix with the treat gas 273 at a point that is immediately upstream from the one or more inlets where the treat gas 273 enters the hydrocracking reactor 220 and/or pretreating reactor 215. In the embodiment depicted in FIG. 2, the mixture of quenching agent 280 and treat gas 273 may then be 1) conveyed into the hydrocracking reactor 220 via the inlets 274, 275, and 276, 2) conveyed into the pretreating reactor via inlets 278, 279 and/or 3) conveyed via conduit 271 to mix with the feedstock at a point 272 located upstream from the charge heater 210.

In certain embodiments, the system also includes one or more valves that when opened, stop the addition of water to the system, thereby increasing recycling of the quenching agent to the reaction zone of the hydroprocessing reactor and amplifying the quenching effect. Again referring to the embodiment depicted in FIG. 2, valve 252 can be closed to prevent the addition of wash water 250 to the system.

Optionally, the valves that control entry of quenching agent or wash water may be automated to be operated (i.e. opened and closed) remotely by control panel 295. FIG. 2 depicts control panel 295 operably connected to remotely control the operation of valve 291 and valve 252 via an electrical signal. In certain embodiments, each valve may comprise motorized or hydraulic components adapted to operate the valve in response to an electric signal input, and operation of each valve may be controlled independently from the other valves by the control panel. Further, the control panel 295 may be electrically interfaced with, and operable to receive electrical signal input from one or more temperature sensors located on or within the hydrotreating reactor. In the embodiment depicted in FIG. 2, a temperature sensor 296 provides electrical signal input to control panel 295. When the control panel 295 detects a temperature electrical signal input from temperature sensor 296 that exceeds a predetermined threshold temperature, control panel 295 sends an electrical signal to open valves 291 and/or 252, thereby rapidly quenching the over-temperature condition via the mechanisms described previously. In certain embodiments, the predetermined threshold temperature within the hydrocracking reactor that necessitates intervention according to the inventive processes and systems described herein may be, for example, 476° C. (825° F.), 479° C. (830° F.), 482° C. (835° F.), 484° C. (840° F.), 487° C. (845° F.), or even 490° C. (850° F.).

The inventive systems and processes disclosed herein are not envisioned to completely replace emergency de-pressurization of a hydroprocessing reaction as an option for responding to extreme temperature spikes and excursions above normal operating temperature. However, the inventive systems and processes disclosed herein do provide a more environmentally-acceptable alternative response to a hydroprocessing over-temperature event; A response that increases the quenching effectiveness, thereby preventing the need for more drastic depressurization of the system. Such depressurization events may violate emission regulations and should be avoided if at all possible.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. Thus, the scope of the invention disclosed herein is specifically intended to be as broad as is legally defined by the claims and any variations and equivalents that are encompassed by the scope of the claims.

We claim:

1. A system for quenching a catalytic hydroprocessing reaction, comprising:
a) a hydroprocessing reactor comprising a reaction zone and containing a hydroprocessing catalyst comprising at least one acidic catalytic active site, wherein the hydroprocessing reactor is operable to be maintained at a temperature and pressure that facilitates hydroprocessing reactions, wherein the hydroprocessing reactor is further operable to facilitate contact between the acidic catalytic sites of the hydroprocessing catalyst and a feedstock derived from at least one of petroleum or biomass to produce a reactor effluent;
b) a vessel operably connected to the hydroprocessing reactor via a conduit comprising a valve, wherein the vessel is operable to contain a quenching agent that is operable to bind the at least one acidic catalytic active site, wherein the valve is operable to release the quenching agent into the conduit and the conduit is operable to convey the quenching agent to the hydroprocessing reactor reaction zone.
c) at least one temperature sensor operably connected to the hydroprocessing reactor that is operable to send an electrical signal indicating the temperature condition within the reaction zone;
d) a control panel that is operable to receive and interpret the electrical signal from the at least one temperature sensor, and further operable to signal the first valve to operate to release the quenching agent when the electrical signal from the temperature sensor indicates a temperature condition that exceeds a first predetermined threshold temperature.

2. The system of claim 1, further comprising a second conduit that is operable to convey the reactor effluent from the hydroprocessing reactor, wherein the second conduit comprises a second valve operable to receive wash water to mix with the reactor effluent, wherein the second valve is operable to close in response to a signal from the control panel, wherein the control panel operates to send the signal to the second valve in response to an electrical signal from the temperature sensor indicating a temperature condition that exceeds a second predetermined threshold temperature.

3. The system of claim 2, wherein the first and second valves are independently operable via motorized or hydraulic components in response to an electric signal from the control panel.

4. The system of claim 1, further comprising a pretreating reactor operably connected upstream from the hydroprocessing reactor, wherein the pretreating reactor contains one or more catalysts operable to catalyze at least one of de-aromatization, de-metallization, hydrodesulfurization, hydrodenitrogenation, and wherein the pretreating reactor is operable to be maintained at a temperature and pressure that facilitates at least one of de-aromatization, de-metallization, hydrodesulfurization and hydrodenitrogenation reactions.

5. The system of claim 1, wherein the quenching agent comprises ammonia or a compound that is converted to ammonia at a temperature and pressure that facilitate hydroprocessing reactions.

6. The system of claim 1, wherein the vessel is operable to contain the quenching agent at a pressure in a range from 100 to 4000 psig.

7. The system of claim 1, wherein the first predetermined threshold temperature is at least 473° C. (820° F.).

8. The system of claim 1, wherein the first predetermined threshold temperature is at least 476° C. (825° F.).

9. The system of claim 1, wherein the first predetermined threshold temperature is at least 479° C. (830° F.).

10. The system of claim 1, wherein the first predetermined threshold temperature is at least 482° C. (835° F.).

11. The system of claim 1, wherein the first predetermined threshold temperature is at least 484° C. (840° F.).

12. The system of claim 1, wherein the first predetermined threshold temperature is at least 487° C. (845° F.).

13. The system of claim 1, wherein the first predetermined threshold temperature is at least 490° C. (850° F.).

14. The system of claim 1, wherein the second predetermined threshold temperature is equal to or greater than the first predetermined threshold temperature.

15. The system of claim 1, wherein the hydroprocessing reactor is configured to facilitate exothermic reactions selected from hydrocracking, hydrodemethylation and combinations thereof.

16. The system of claim 1, wherein the hydroprocessing catalyst is a hydrocracking catalyst.
